(19) United States
(12) Patent Application Publication
(10) Pub. No.: US 2015/0254554 A1
(43) Pub. Date: Sep. 10, 2015

(54) INFORMATION PROCESSING DEVICE AND LEARNING METHOD

(71) Applicant: NEC Corporation, Tokyo (JP)

(72) Inventor: Kyoko KATO, Tokyo (JP)

(73) Assignee: NEC Corporation, Tokyo (JP)

(21) Appl. No.: 14/628,681

(22) Filed: Feb. 23, 2015

(30) Foreign Application Priority Data
Mar. 4, 2014 (JP) 2014-041228

(51) Int. Cl. G06N 3/08; G06N 3/04

(52) U.S. Cl. CPC G06N 3/08; G06N 3/04

(57) ABSTRACT

An information processing device which generates a prediction model on time-series data by using neural networks in a short time is provided. A prediction model learning unit 121 learns a prediction model including a first neural network, a second neural network, and a third neural network. To the first neural network and a second neural network, subsets obtained by dividing a set that includes the time-series data values as elements are inputted respectively. To the third neural network, an inner product of outputs from the first neural network and the second neural network is inputted. The third neural network outputs a predicted data value for the prediction target type as of a prediction target time.

This application is based upon and claims the benefit of priority from Japanese Patent Application No. 2014-041228, filed on Mar. 4, 2014, the disclosure of which is incorporated herein in its entirety by reference.

### TECHNICAL FIELD

The present invention relates to an information processing device and a learning method, in particular to an information processing device and a learning method for making predictions on time-series data.

### BACKGROUND ART

With the evolution and widespread use of information technology (IT), a greater amount of information is being accumulated in the form of electronic data. Meanwhile, the recent availability of inexpensive and a huge number of calculator resources has established environments for utilizing a huge amount of data. In such circumstances, there exists a need to analyze the accumulated information to be utilized for decision-making. For example, predictions are made with time-series data (time-series prediction) in a wide range of applications, such as commodity or electricity demand forecasting and weather forecasting. A variety of techniques such as multiple regression analysis and neural networks are used for time-series prediction; hierarchical neural networks, among others, are excellent in noise removal and are often used for predictions on cyclic data.

A method for making time-series predictions by using such hierarchical neural networks has been disclosed, for example, in Japanese Laid-open Patent Publication No. 2002-109150.

As a related art, Bing Bai, et al, “Supervised Semantic Indexing”, Conference: International Conference on Information and Knowledge Management—CIKM, pp. 761-765, 2009 discloses Supervised Semantic Indexing (SSI), which is one technique for supervised machine learning algorithms.

Time-series data predictions with neural networks require appropriate selection of input parameters for every prediction target. As input parameters, not only actual measured data values for a prediction target but also their processed values may be used. For example, a difference value, average, or standard deviation calculated from actual measured values, or flagged day-of-week or holiday data based on date and time information may be used as input parameters. Moreover, data affecting a prediction target, such as weather data for a target region, may also be used as input parameters.

As seen above, there are a myriad of possible input parameters for making prediction. Thus, to improve prediction accuracy of a neural network, the user has to continue a process of trial and error, for example, by learning and predicting repeatedly while reviewing results and selecting parameters as inputs from a huge number of parameters. That is, it takes a very long time to obtain an optimum prediction model.

### SUMMARY

An exemplary object of the present invention is to provide an information processing device and a learning method which make it possible to generate a prediction model on time-series data in a short time by using neural networks.

An information processing device according to an exemplary aspect of the invention includes: a data acquisition unit which acquires time-series data values for at least one of a prediction target type and another type that potentially affects the prediction target type; and a prediction model learning unit which learns a prediction model including a first neural network and a second neural network to which subsets obtained by dividing a set that includes the time-series data values as elements are inputted respectively, and a third neural network to which an inner product of outputs from the first neural network and the second neural network is inputted and which outputs a predicted data value for the prediction target type as of a prediction target time.

A learning method according to an exemplary aspect of the invention includes: acquiring time-series data values for at least one of a prediction target type and another type that potentially affects the prediction target type; and learning a prediction model including a first neural network and a second neural network to which subsets obtained by dividing a set that includes the time-series data values as elements are inputted respectively, and a third neural network to which an inner product of outputs from the first neural network and the second neural network is inputted and which outputs a predicted data value for the prediction target type as of a prediction target time.

A non-transitory computer readable storage medium according to an exemplary aspect of the invention records thereon a program, causing a computer to perform a method including: acquiring time-series data values for at least one of a prediction target type and another type that potentially affects the prediction target type; and learning a prediction model including a first neural network and a second neural network to which subsets obtained by dividing a set that includes the time-series data values as elements are inputted respectively, and a third neural network to which an inner product of outputs from the first neural network and the second neural network is inputted and which outputs a predicted data value for the prediction target type as of a prediction target time.

### BRIEF DESCRIPTION OF THE DRAWINGS

Exemplary features and advantages of the present invention will become apparent from the following detailed description when taken with the accompanying drawings in which:

FIG. 1 is a block diagram illustrating a characteristic configuration of a first exemplary embodiment of the present invention;

FIG. 2 is a block diagram illustrating a configuration of a learning device 100 according to the first exemplary embodiment of the present invention;

FIG. 3 illustrates an example prediction model according to the first exemplary embodiment of the present invention;

FIG. 4 illustrates example datasets of learning data according to the first exemplary embodiment of the present invention;

FIG. 5 illustrates example datasets of learning data and predictive data according to the first exemplary embodiment of the present invention;

FIG. 6 illustrates a learning process flowchart according to the first exemplary embodiment of the present invention;

FIG. 7 illustrates a prediction process flowchart according to the first exemplary embodiment of the present invention;

FIG. 8 is a block diagram illustrating a configuration of a learning device 100 according to a second exemplary embodiment of the present invention;

FIG. 9 illustrates an example analysis model according to the second exemplary embodiment of the present invention;

FIG. 10 illustrates a learning process flowchart according to the second exemplary embodiment of the present invention;

FIG. 11 illustrates an analysis process flowchart according to the second exemplary embodiment of the present invention;

FIG. 12 illustrates a method for calculating weights according to the second exemplary embodiment of the present invention;

FIG. 13 illustrates example calculated weights of the respective element pairs according to the second exemplary embodiment of the present invention; and

FIG. 14 illustrates example calculated weights of the respective elements according to the second exemplary embodiment of the present invention.

### EXEMPLARY EMBODIMENT

### First Exemplary Embodiment

A first exemplary embodiment of the present invention will now be described.

First, a prediction model according to the first exemplary embodiment of the present invention is described.

In the first exemplary embodiment of the present invention, Supervised Semantic Indexing (SSI) mentioned above is used for the prediction model. SSI is a technique devised for calculating similarities between text sets such as documents or web pages, representing a machine learning algorithm for learning an optimum output from two input data groups. The first exemplary embodiment of the present invention performs deep learning by applying a hierarchical neural network to the learning model inside SSI.

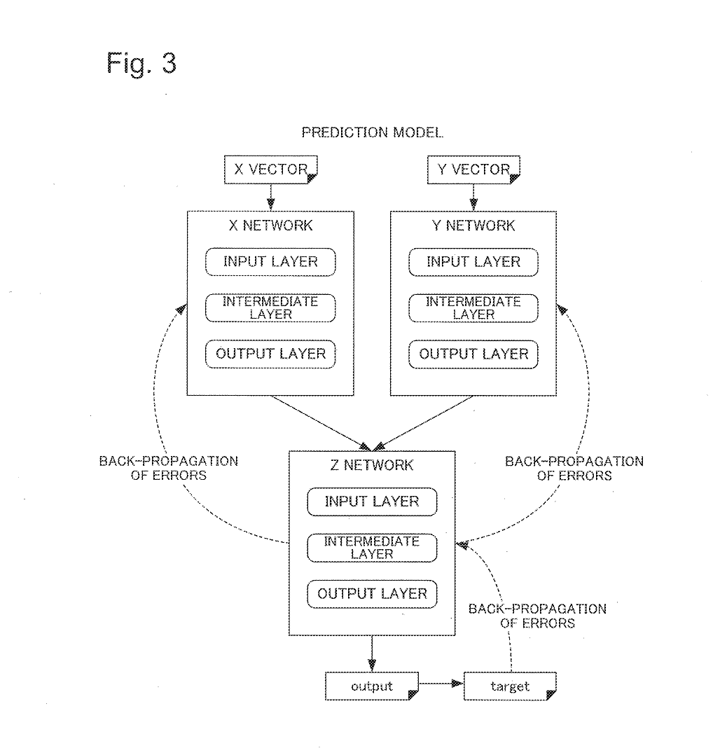

FIG. 3 illustrates an example prediction model according to the first exemplary embodiment of the present invention.

As shown in FIG. 3, a prediction model according to the first exemplary embodiment of the present invention is composed of three neural networks (X network, Y network, and Z network). Each of the three neural networks is a three-or-more-layer hierarchical neural network composed of an input layer, one or more intermediate layers, and an output layer. Alternatively, any of these neural networks may be a two-layer neural network without intermediate layers.

As inputs to the prediction model, X and Y vectors are inputted to the X and Y networks, respectively. To the Z network, an inner product (cosine similarity) of the output vectors from the X and Y networks is inputted. The Z network outputs a prediction value, which is the output value (output) of the prediction model.

Preferably, elements of the respective X and Y vectors, which are inputs to the prediction model, are defined so as to be correlated between elements of the X and Y vectors.

The first exemplary embodiment of the present invention predicts data values for the target type to be predicted (prediction target type) by using time-series data values for at least one of the prediction target type and another type that potentially affects the prediction target type.

To the X and Y vectors of the prediction model, subsets obtained by dividing a set that include the time-series data values for at least one of the prediction target type and another type are given respectively, as elements. Data values as of predetermined times relative to the prediction target time are given to the set as elements. Then, as an output from the Z network, a predicted data value for the prediction target type as of the time for prediction target (prediction target time) is outputted.

As an example, the following description assumes that the prediction target type is power consumption and the prediction target time is one hour later; that is, a prediction is made for a power consumption value as of one hour later. This example also assumes that a holiday flag (a flag indicating weekday or holiday) is used as another type that potentially affects the prediction target type. In this case, to the X and Y vectors of the prediction model, for example, subsets obtained by dividing a set of values representing actual measured values of power at or before the current time and values of the holiday flag at or before the time one hour after the current time are given. For example, as elements of the X vector, actual measured values in the past (an actual measured value one hour before, an actual measured value two hours before, . . . , an actual measure value N hours before) are given. As elements of the Y vector, an actual measure value of power as of the current time and a holiday flag as of the prediction target time are given. Note that other types except the holiday flag may also be used, such as weather or temperature at, before, or after the prediction target time.

Also note that various values may be used as data values of other types, such as a difference from the actual measured value at one hour before, a moving average of actual measured values within any period, a standard deviation, a minimum value, a maximum value, a median value, or a combination thereof, for the prediction target type.

Any value used for respective elements of the X and Y vectors is normalized to a value between 0 and 1.

Now a configuration of the first exemplary embodiment of the present invention is described below.

FIG. 2 is a block diagram illustrating a configuration of a learning device 100 according to the first exemplary embodiment of the present invention. The learning device 100 represents an exemplary embodiment of the information processing device of the present invention. With reference to FIG. 2, the learning device 100 according to the first exemplary embodiment of the present invention includes a process accepting unit 110, a learning unit 120, a prediction unit 130, and a prediction model storage unit 140.

The process accepting unit 110 accepts a request for learning or prediction sent from a user and returns the result to the user. The process accepting unit 110 includes a data acquisition unit 111. The data acquisition unit 111 acquires learning data and predictive data from the user. Alternatively, the data acquisition unit 111 may acquire learning data and predictive data from another device or a storage unit (not shown).

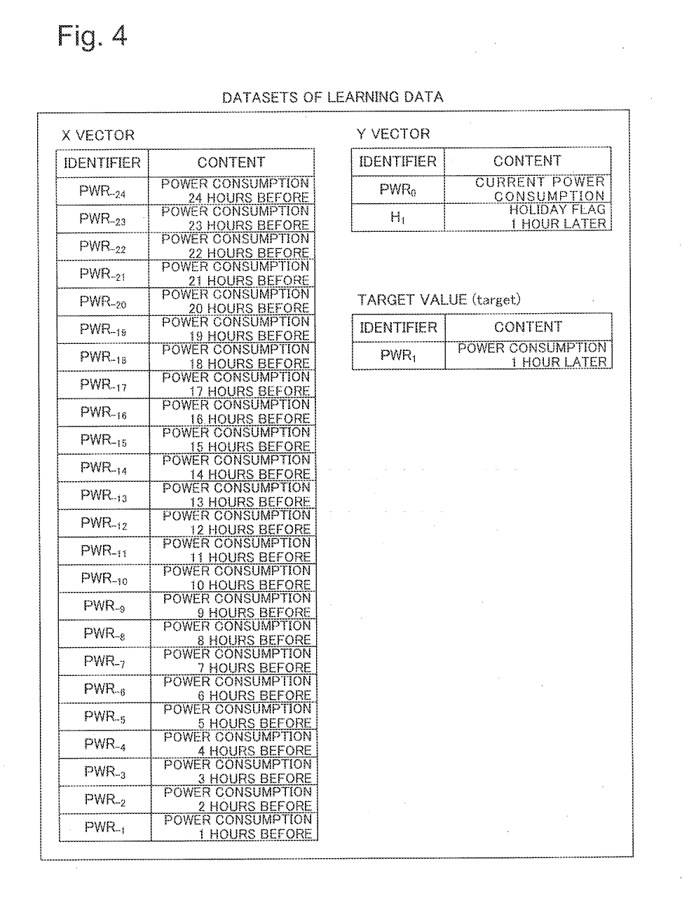

FIG. 4 illustrates example datasets of the learning data according to the first exemplary embodiment of the present invention.

The learning data represents datasets which cover the learning period and are composed of the inputs to the prediction model, i.e., the X and Y vectors, and a correct value (target) of a predicted value.

FIG. 4 illustrates example datasets of learning data for the above-described power consumption prediction. In the example shown in FIG. 4, actual measured values of power consumption in the past are given as the X vector, an actual measured value of power consumption as of the current time and a holiday flag at the prediction target time are given as the Y vector, and an actual measure value of power consumption at the prediction target time is given as the correct value (target).

The predictive data represents datasets which cover the prediction period being different from the learning period and are composed of the inputs to the prediction model, i.e., the X and Y vectors. The datasets of predictive data may also include a correct value of a prediction value. In this case, the correct value is used for calculating an error rate compared with a predicted value.

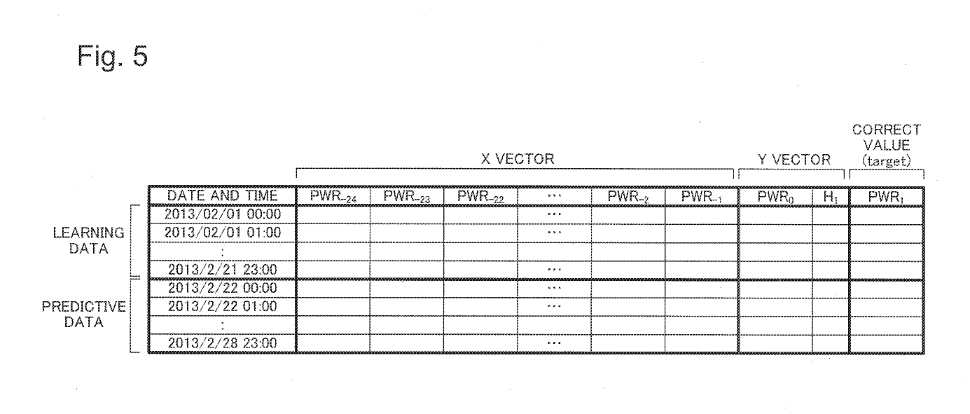

FIG. 5 illustrates example datasets of the learning data and the predictive data according to first exemplary embodiment of the present invention.

The example shown in FIG. 5 uses datasets for the learning period: 2013/02/1 00:00 to 2013/02/21 23:00 and the prediction period: 2013/02/22 00:00 to 2013/02/28 23:00 at intervals of one hour.

The data acquisition unit 111 may optionally generate learning data and predictive data in a format similar to that in FIG. 5 based on time-series data values for the prediction target type and other types.

The learning unit 120 includes a prediction model learning unit 121. The prediction model learning unit 121 learns (generates and optimizes) a prediction model based on the learning data.

The prediction unit 130 predicts a data value for the prediction target type as of the prediction target time by using the predictive data and prediction model.

The prediction model storage unit 140 stores the prediction model generated by the prediction model learning unit 121.

Note that the learning device 100 may be a computer which includes a central processing unit (CPU) and a storage medium storing a program and which operates according to the program-based control. In this case, the CPU in the learning device 100 executes a computer program to implement the functions of the process accepting unit 110, learning unit 120, and prediction unit 130. The storage medium in the learning device 100 stores information in the prediction model storage unit 140.

Now operations of the learning device 100 according to the first exemplary embodiment of the present invention will be described below. The operations of the learning device 100 are divided into a learning process and a prediction process.

First, the learning process according to the first exemplary embodiment of the present invention is described.

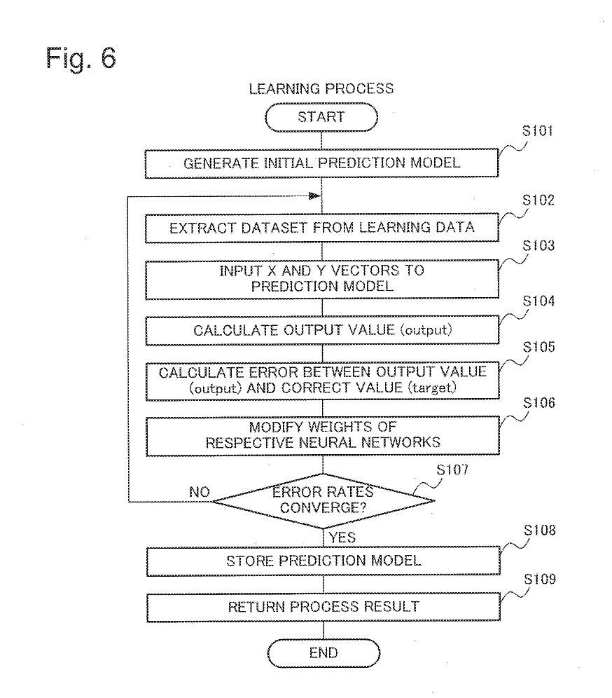

FIG. 6 is a flowchart of the learning process according to the first exemplary embodiment of the present invention.

The learning unit 120 accepts a request for learning sent from a user through the process accepting unit 110. The learning unit 120 obtains learning data from the data acquisition unit 111.

The prediction model learning unit 121 in the learning unit 120 generates an initial prediction model (Step S101). In the initial prediction model, weights in the respective neural networks (X network, Y network, and Z network) are defined, for example, at random. Alternatively, predetermined initial values of weights may be given to the initial prediction model.

The prediction model learning unit 121 randomly extracts a dataset (X vector, Y vector, and a correct value (target)) from the learning data (Step S102).

The prediction model learning unit 121 inputs the X and Y vectors out of the extracted dataset to the prediction model (Step S103), and calculates an output value (output) (Step S104).

The prediction model learning unit 121 calculates an error between the output value (output) and correct value (target) (Step S105).

The prediction model learning unit 121 modifies the weights in the respective neural networks (X network, Y network, and Z network) based on the calculated error (Step S106). The prediction model learning unit 121 modifies the weights in the Z network through back-propagation of errors in the Z network as shown in FIG. 3. Then, the prediction model learning unit 121 performs back-propagation of errors from the Z network to the X and Y networks. The prediction model learning unit 121 modifies the respective weights in the X and Y networks through back-propagation of errors in the X and Y networks.

The prediction model learning unit 121 repeats the process starting from Step S102 until error rates converge (Step S107).

If error rates have converged (Y in Step S107), the prediction model learning unit 121 stores the learned (generated) prediction model into the prediction model storage unit 140 (Step S108).

The learning unit 120 returns the process result (a prediction model has been learned) to the user through the process accepting unit 110 (Step S109).

Now, the prediction process according to the first exemplary embodiment is described. The prediction process is carried out after a prediction model is generated through the learning process.

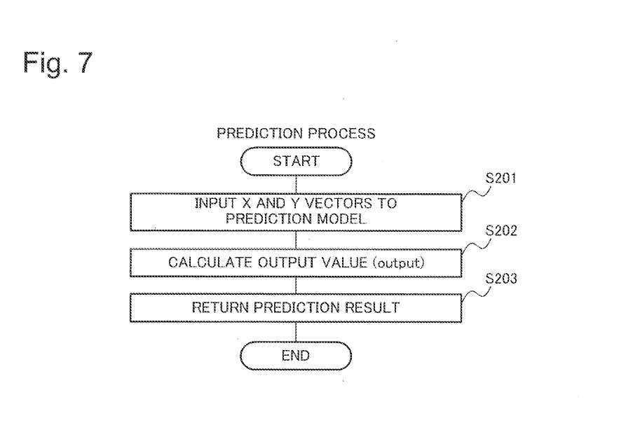

FIG. 7 is a flowchart of the prediction process according to the first exemplary embodiment of the present invention.

The prediction unit 130 accepts a request for prediction sent from a user through the process accepting unit 110. The prediction unit 130 obtains predictive data from the data acquisition unit 111.

The prediction unit 130 extracts a dataset (X and Y vectors) from the predictive data, inputs it to the prediction model (Step S201), and then calculates an output value (output) (Step S202).

The learning unit 120 returns the calculated output value (output) as a prediction result to the user through the process accepting unit 110 (Step S203). Alternatively, the learning unit 120 may output the prediction result to a storage unit (not shown) or to any other device.

The operations according to the first exemplary embodiment of the present invention are now finished.

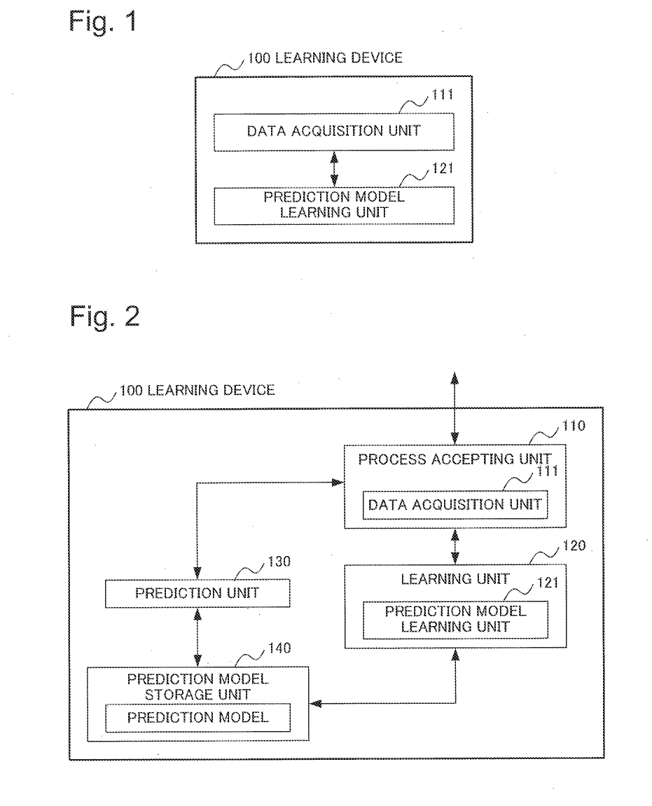

Now a characteristic configuration of the first exemplary embodiment of the present invention is described below. FIG. 1 is a block diagram illustrating a characteristic configuration of the first exemplary embodiment of the present invention.

With reference to FIG. 1, a learning device 100 (information processing device) includes a data acquisition unit 111 and a prediction model learning unit 121.

The data acquisition unit 111 acquires time-series data values for at least one of a prediction target type and another type that potentially affects the prediction target type.

The prediction model learning unit 121 learns a prediction model including a first neural network (X network), a second neural network (Y network), and a third neural network (Z network). To the first neural network and a second neural network, subsets obtained by dividing a set that includes the time-series data values as elements are inputted respectively. To the third neural network, an inner product of outputs from the first neural network and the second neural network is inputted. The third neural network outputs a predicted data value for the prediction target type as of a prediction target time.

Next, advantageous effects of the first exemplary embodiment of the present invention are described below.

According to the first exemplary embodiment of the present invention, a prediction model on time-series data can be generated in a short time. This is because the prediction model learning unit 121 learns a prediction model where neural networks are applied to SSI, as a prediction model on time-series data.

A prediction model where neural networks are applied to SSI carries out the learning process rapidly through parallel learning in the respective networks. Thus, the learning time is made short in spite of many input elements (parameters). Additionally, a highly accurate prediction model is generated with a small amount of sample data because learning is performed in two networks (X and Y networks). Accordingly, even if the learning uses the learning data that includes a large number of elements (parameters) without examining the input elements (parameters), a highly accurate prediction model is provided in a short time compared with usual neural networks.

### Second Exemplary Embodiment

A second exemplary embodiment of the present invention will now be described.

The second exemplary embodiment of the present invention is different from the first exemplary embodiment of the invention in that an analysis model is used to calculate weights of respective elements of the X and Y vectors.

First, a prediction model and an analysis model according to the second exemplary embodiment of the present invention are described.

Like the prediction model according to the first exemplary embodiment of the present invention (FIG. 3), a prediction model according to the second exemplary embodiment of this invention is composed of three neural networks (X network, Y network, and Z network). In this model, at least the X and Y networks are each hierarchical network formed of three or more layers.

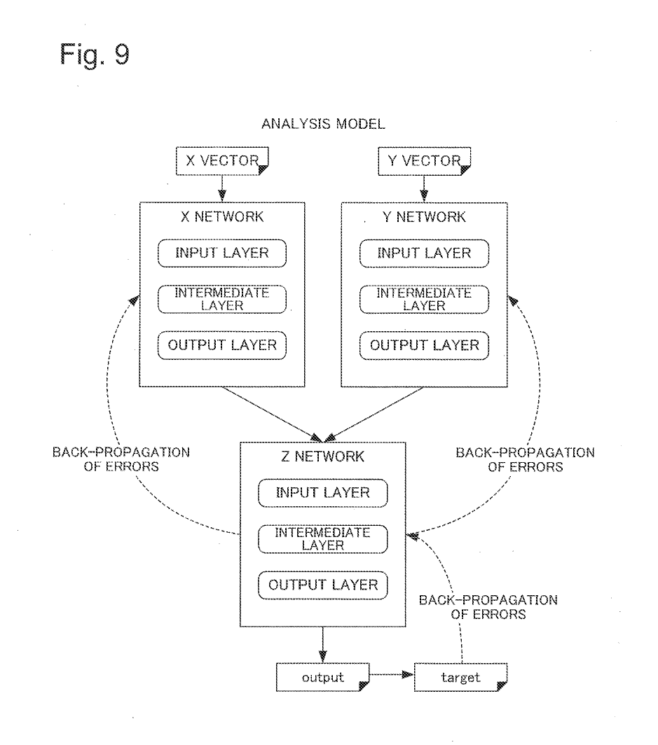

FIG. 9 illustrates an example analysis model according to the second exemplary embodiment of the present invention.

Like the prediction model, an analysis model according to the second exemplary embodiment of the present invention is composed of three neural networks (X network, Y network, and Z network). Unlike the prediction model, however, the X and Y networks of the analysis model are each two-layer neural networks without intermediate layers.

To the X and Y vectors of the analysis model, the same subsets of data values as the ones in the prediction model are given respectively. Similar to the prediction model, as an output from the Z network, a predicted data value for the prediction target type as of the prediction target time is outputted.

Now a configuration of the second exemplary embodiment of the present invention is described below.

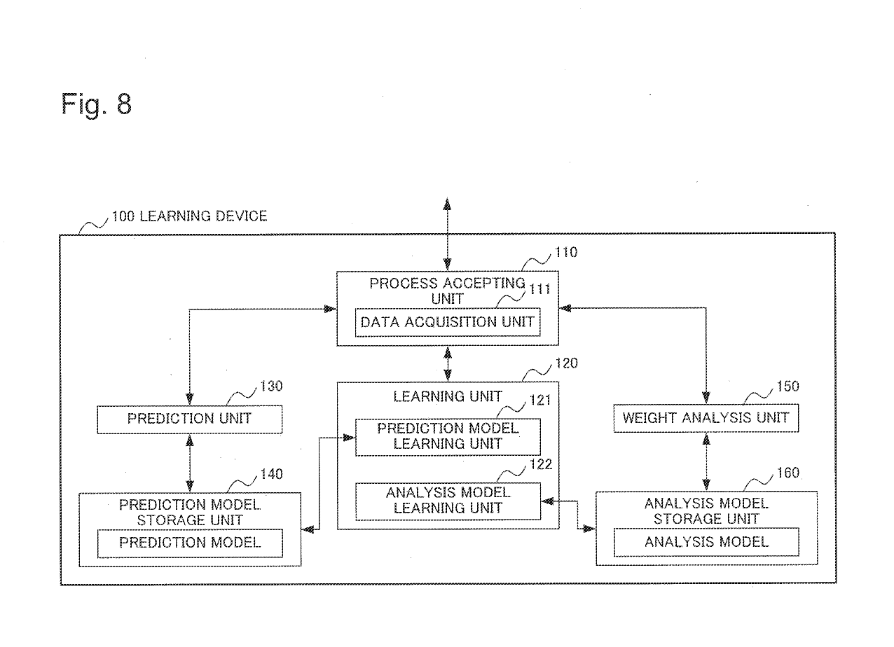

FIG. 8 is a block diagram illustrating a configuration of a learning device 100 according to the second exemplary embodiment of the present invention. With reference to FIG. 8, the learning device 100 according to the second exemplary embodiment of the present invention includes a weight analysis unit 150 and an analysis model storage unit 160, in addition to the configuration according to the first exemplary embodiment of the present invention. Furthermore, the learning unit 120 includes an analysis model learning unit 122 in addition to the prediction model learning unit 121.

The analysis model learning unit 122 learns (generates and optimizes) an analysis model based on the learning data.

The weight analysis unit 150 calculates weights of respective elements of the X and Y vectors that are inputted to the analysis model.

The analysis model storage unit 160 stores the analysis model generated by the analysis model learning unit 122.

Now operations of the learning device 100 according to the second exemplary embodiment of the present invention will be described below. The operations of the learning device 100 are divided into a learning process, a prediction process, and an analysis process.

First, the learning process according to the second exemplary embodiment of the present invention is described.

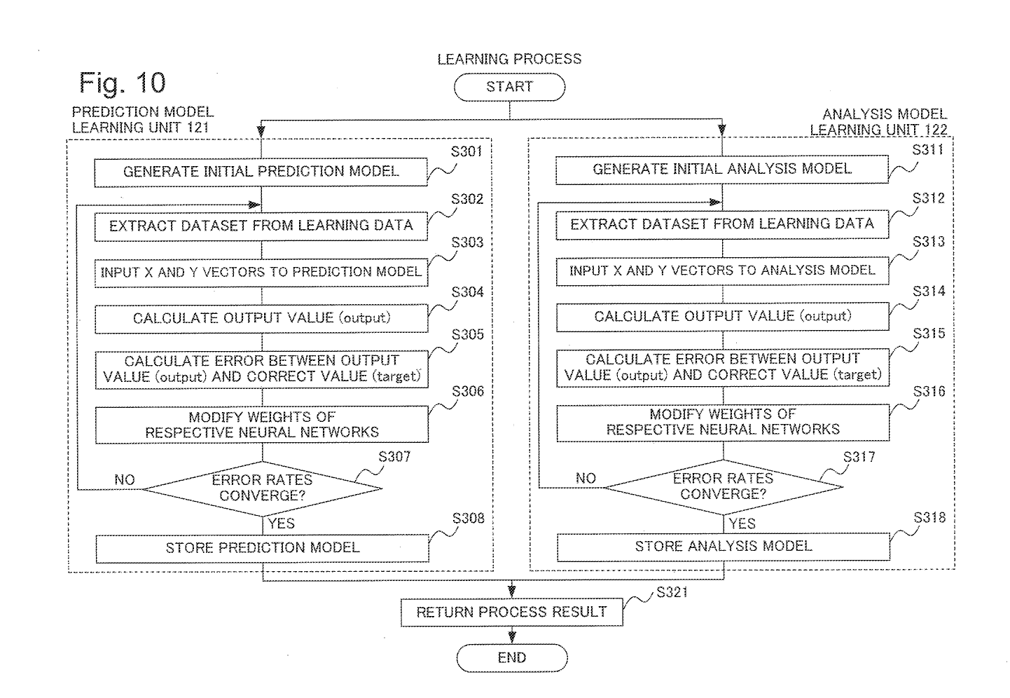

FIG. 10 is a flowchart of the learning process according to the second exemplary embodiment of the present invention.

The learning unit 120 accepts a request for leaning sent from a user through the process accepting unit 110. The learning unit 120 obtains learning data from the data acquisition unit 111.

The prediction model learning unit 121 in the learning unit 120 generates a prediction model based on the learning data and stores the prediction model into the prediction model storage unit 140 (Steps S301 to S308) in the same manner as in the learning process according to the first exemplary embodiment of the present invention (Steps S101 to S108).

Likewise, the analysis model learning unit 122 generates the above-described analysis model based on the learning data and stores the analysis model into the analysis model storage unit 160 (Steps S311 to S318) in the same manner as in the learning process according to the first exemplary embodiment of the present invention (Steps S101 to S108).

The learning unit 120 returns the process results (prediction and analysis models have been learned) to the user through the process accepting unit 110 (Step S321).

Next, the prediction process according to the second exemplary embodiment is described.

The prediction process according to the second exemplary embodiment of the present inventions is the same as the prediction process according to the first exemplary embodiment of the invention (Steps S201 to S203).

Next, a description is provided about the analysis process according to the second exemplary embodiment of the present invention. The analysis process is carried out after an analysis model is generated through the learning process.

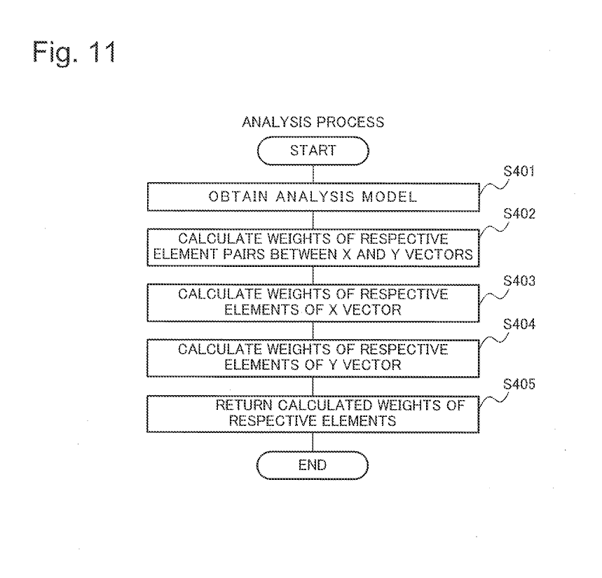

FIG. 11 is a flowchart of the analysis process according to the second exemplary embodiment of the present invention.

The weight analysis unit 150 accepts a request for weight analysis sent from a user through the process accepting unit 110.

The weight analysis unit 150 obtains the analysis model from the analysis model storage unit 160 (Step S401).

The weight analysis unit 150 calculates weights of respective element pairs between the X and Y vectors by using the analysis model (Step S402).

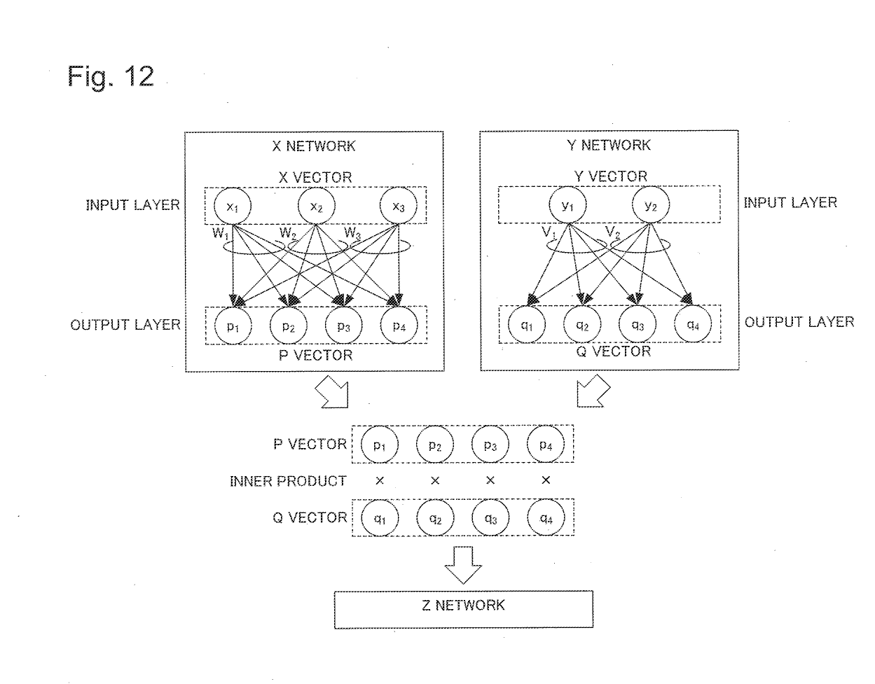

FIG. 12 illustrates a method for calculating a weight according to the second exemplary embodiment of the present invention.

In the example shown in FIG. 12, the X vector is three dimensional: X=(x₁, x₂, x₃) and the Y vector is two dimensional: Y=(y₁, y₂). The output of the X network (P vector) is four dimensional: P=(p₁, p₂, p₃, p₄) and the output of the Y network (Q vector) is four dimensional: Q=(q₁, q₂, q₃, q₄).

W1, W2, and W3 each represent weight vectors of the elements x₁, x₂, and x₃ onto the P vector: W₁=(w₁₁, w₁₂, w₁₃, w₁₄), W₂=(w₂₁, w₂₂, w₂₃, w₂₄), W₃=(w31, w32, w33, w34). V1 and V2 each represent weight vectors of the elements y₁ and y₂ onto the Q vector: V₁=(v₁₁, v₂₁, v₃₁, v₄₁), V₂=(v₁₂, v₂₂, v₃₂, v₄₂).

An input to the Z network is calculated as the inner product of the P and Q vectors. This inner product of the P and Q vectors can undergo matrix transformation as in the following equation 1.

$$P \cdot Q = ( {x}_{1} , {x}_{2} , {x}_{3} ) ( \begin{matrix}{w}_{11} , {w}_{12} , {w}_{13} , {w}_{14} \\ {w}_{21} , {w}_{22} , {w}_{23} , {w}_{24} \\ {w}_{31} , {w}_{32} , {w}_{33} , {w}_{34}\end{matrix} ) ( \begin{matrix}{v}_{11} , {v}_{12} \\ {v}_{21} , {v}_{22} \\ {v}_{31} , {v}_{32} \\ {v}_{41} , {v}_{42}\end{matrix} ) ( \begin{matrix}{y}_{1} \\ {y}_{2}\end{matrix} ) = ( {x}_{1} , {x}_{2} , {x}_{3} ) ( \begin{matrix}{d}_{11} , {d}_{12} \\ {d}_{21} , {d}_{22} \\ {d}_{31} , {d}_{32}\end{matrix} ) ( \begin{matrix}{y}_{1} \\ {y}_{2}\end{matrix} ) \qquad [ Equation 1 ]$$

Thus, a weight d₁₁ of the element pair x₁ and y₁ can be calculated as an inner product of the W₁ and V₁ vectors.

That is, assuming that X is (x₁, x₂, xₘ) and Y is (y₁, y₂, . . . yₙ) (where m and n each represent the number of dimensions of the X and Y vectors, respectively), a weight dᵢⱼ of the pair of the X vector element xᵢ and the Y vector element yⱼ can be calculated according to the following equation 2.

dᵢⱼ=Wᵢ·Vⱼ [Equation 2]

In this expression, Wᵢ=(wᵢ₁, wᵢ₂, . . . wᵢₖ), and Vⱼ=(v₁ᵢ, v₂ⱼ, . . . vₖⱼ) (where k is the number of dimensions of the P and Q vectors). Repeating this calculation m×n times produces calculated weights of all the element pairs.

The weight analysis unit 150 calculates weights of the respective elements of the X vector based on the weights of the element pairs calculated in Step S402 (Step S403).

A weight dᵢ of the element xᵢ of the X vector is calculated according to the following equation 3.

$${d}_{i} = {\sum }_{j} \vert {d}_{ij} \vert \qquad [ Equation 3 ]$$

Repeating this calculation m times produces calculated weights of all the elements of the X vector.

Likewise, the weight analysis unit 150 calculates weights of the respective elements of the Y vector based on the weights of the element pairs calculated in Step S402 (Step S404).

A weight dⱼ of the element yⱼ of the Y vector onto the input to the Z network is calculated according to the following equation 4.

$${d}_{j} = {\sum }_{i} \vert {d}_{ij} \vert \qquad [ Equation 4 ]$$

Repeating this calculation n times produces calculated weights of all the elements of the Y vector.

The weight analysis unit 150 returns the weights of the respective elements calculated in Steps S403 and S404 as a calculation result to the user through the process accepting unit 110 (Step S405). Alternatively, the weight analysis unit 150 may output the weights of the respective elements to a storage unit (not shown) or to any other device.

The analysis model according to the second exemplary embodiment of the present invention represents the SSI-based prediction model where intermediate layers are eliminated in the X and Y networks. Eliminating intermediate layers in widely used general three-layer neural networks results in being equivalent to regression analysis. On the other hand, SSI retains a hierarchical neural network even if intermediate layers are eliminated in the X and Y networks because SSI combines a plurality of hierarchical neural networks into multilevels. In addition, contribution per layer in a hierarchical neural network decreases as the number of layers increases. Thus, a fewer-layer model than the prediction model by one layer, like the analysis model, is not subject to significant loss of characteristics of the prediction model.

Accordingly, it is believed that weights of the respective elements of the X and Y vectors in the analysis model, although they are not identical to the weights of the respective elements of the X and Y vectors in the prediction model, approximate trends in the weights in the prediction model to some extent.

The user can estimate weights (influences on predicted values) of the respective elements in the prediction model based on the weights of the respective elements in the analysis model.

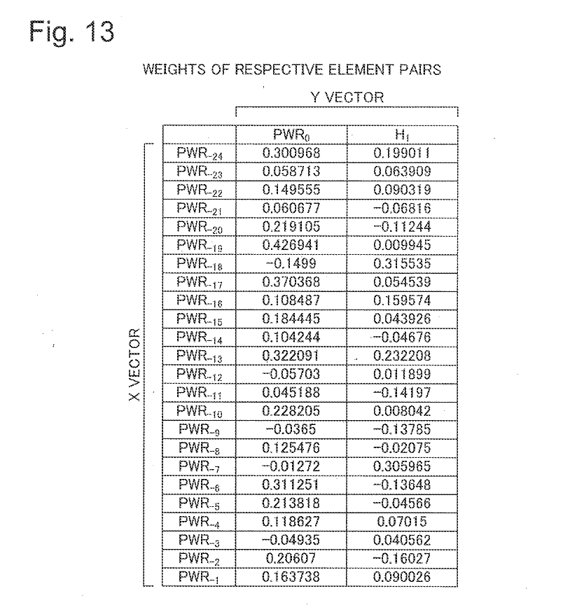

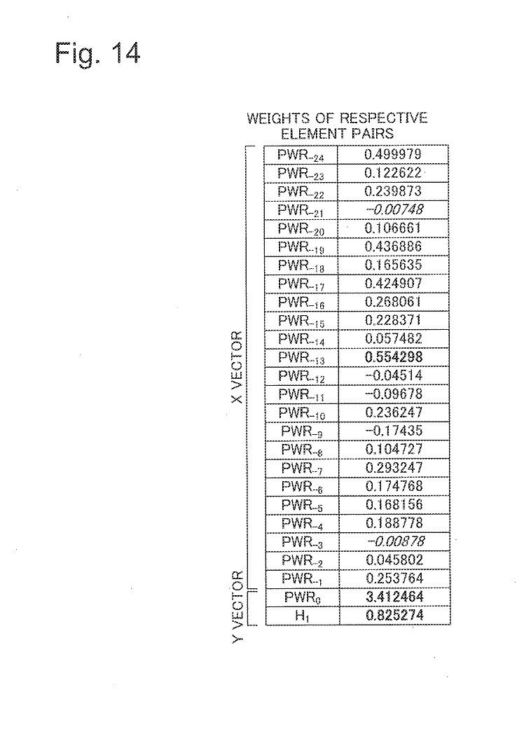

FIG. 13 illustrates example calculated weights of the respective element pairs according to the second exemplary embodiment of the present invention. The weights shown in FIG. 3 are calculated for the learning data in FIG. 4. FIG. 14 illustrates example calculated weights of the respective elements according to the second exemplary embodiment of the present invention. The weights shown in FIG. 14 are calculated based on the weights of the respective element pairs in FIG. 13.

In the example in FIG. 14, the elements PWR₀, H₁, and PWR₋₁₃, which have greater weights, represent greater influences on predicted values. In contrast, the elements PWR₋₂₁ and PWR₋₃, which have weights of almost 0, represent little influence on predicted values.

If the prediction model is of a high prediction accuracy, the user can retain the (important) elements having greater weights as calculated by using the analysis model in the learning data while deleting the (unimportant) elements having smaller weights from the learning data. To the contrary, if the prediction model is of a low prediction accuracy, the user can delete the elements (that might be adversely affecting predicted values) having greater weights from the learning data.

In this way, the user can improve accuracy of a prediction model by selecting elements having greater influences on predicted values based on the weights calculated according to an analysis model, and by re-training the learning data that reflects the selected elements.

The operations according to the second exemplary embodiment of the present invention are now finished.

In the second exemplary embodiment of the present invention, datasets are randomly extracted in learning prediction and analysis models (Steps S302 and S312). However, this is not a limitation; for example, a common process for dataset extraction may be employed to use the same dataset for learning both the prediction and analysis models.

In the second exemplary embodiment of the present invention, both the prediction and analysis models are learned simultaneously. However, this is not a limitation; for example, an analysis model may be learned continuously and the process of calculating weights of respective elements and selecting elements may be repeated, and when some higher prediction accuracy is established by an analysis model, then a prediction model may be generated through the use of the selected elements.

In the second exemplary embodiment of the present invention, the user selects elements of the learning data based on the weights of the respective elements as calculated according to the analysis model. However, this is not a limitation; for example, the weight analysis unit 150 may select elements of the learning data based on the weights of the respective elements as calculated according to the analysis model, and then instruct the learning unit 120 to re-learn the prediction and analysis models.

As an alternative to selecting elements, element pairs of the learning data may be selected based on the weights of the respective element pairs as calculated according to the analysis model.

Effects of the second exemplary embodiment of the present invention are described below.

In a usual hierarchical neural network, its internal configuration forms a black box due to the non-linearity of elements, and thus influences (weights) of the respective input elements (parameters) on the output values cannot be seen. As a result, it is impossible to obtain indicators serving as criteria for selecting input elements.

The second exemplary embodiment of the present invention makes it possible to provide influences (weights) of the respective elements, which are inputted to a prediction model, on output values. This is achieved because the analysis model learning unit 122 learns an analysis model where intermediate layers are eliminated from the X and Y networks in the prediction model, and the weight analysis unit 150 calculates weights of the respective elements based on the X and Y networks in the analysis model. In this way, this exemplary embodiment allows for selection of elements to be inputted to the prediction model to further improve the prediction accuracy of the prediction model.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. An information processing device comprising:
a data acquisition unit which acquires time-series data values for at least one of a prediction target type and another type that potentially affects the prediction target type; and
a prediction model learning unit which learns a prediction model including a first neural network and a second neural network to which subsets obtained by dividing a set that includes the time-series data values as elements are inputted respectively, and a third neural network to which an inner product of outputs from the first neural network and the second neural network is inputted and which outputs a predicted data value for the prediction target type as of a prediction target time.

2. The information processing device according to claim 1, further comprising:
an analysis model learning unit which learns an analysis model including a fourth neural network and a fifth neural network each of which is composed of an input layer and an output layer and to which the subsets of the set are inputted respectively, and a sixth neural network to which an inner product of outputs from the fourth neural network and the fifth neural network is inputted and which outputs a predicted data value for the prediction target type as of the prediction target time; and
a weight analysis unit which calculates and outputs weights of respective elements included in the set, based on the fourth neural network and fifth neural network.

3. The information processing device according to claim 2, wherein the weight analysis unit calculates weights of respective elements included in the set, based on a weight that are calculated between each of elements in an input layer and each of elements in an output layer in each of the fourth neural network and the fifth neural network through learning the analysis model.

4. The information processing device according to claim 3, wherein the weight analysis unit calculates weights of respective pairs of each of elements inputted to the fourth neural network and each of elements inputted to the fifth neural network from among elements included in the set, based on a weight that are calculated between each of elements in an input layer and each of elements in an output layer in each of the fourth neural network and the fifth neural network through learning the analysis model, and then calculates weights of respective elements included in the set based on the weights of the pairs.

5. The information processing device according to claim 1, wherein the set includes, as an element, a data value as of a predetermined time relative to the prediction target time.

6. A learning method comprising:
acquiring time-series data values for at least one of a prediction target type and another type that potentially affects the prediction target type; and
learning a prediction model including a first neural network and a second neural network to which subsets obtained by dividing a set that includes the time-series data values as elements are inputted respectively, and a third neural network to which an inner product of outputs from the first neural network and the second neural network is inputted and which outputs a predicted data value for the prediction target type as of a prediction target time.

7. The learning method according to claim 6, further comprising:
learning an analysis model including a fourth neural network and a fifth neural network each of which is composed of an input layer and an output layer and to which the subsets of the set are inputted respectively, and a sixth neural network to which an inner product of outputs from the fourth neural network and the fifth neural network is inputted and which outputs a predicted data value for the prediction target type as of the prediction target time; and
calculating and outputting weights of respective elements included in the set, based on the fourth neural network and fifth neural network.

8. The learning method according to claim 7, the calculating weights of respective elements included in the set calculates weights of respective elements included in the set, based on a weight that are calculated between each of elements in an input layer and each of elements in an output layer in each of the fourth neural network and the fifth neural network through learning the analysis model.

9. A non-transitory computer readable storage medium recording thereon a program, causing a computer to perform a method comprising:
acquiring time-series data values for at least one of a prediction target type and another type that potentially affects the prediction target type; and
learning a prediction model including a first neural network and a second neural network to which subsets obtained by dividing a set that includes the time-series data values as elements are inputted respectively, and a third neural network to which an inner product of outputs from the first neural network and the second neural network is inputted and which outputs a predicted data value for the prediction target type as of a prediction target time.

10. The non-transitory computer readable storage medium, according to claim 9, recording thereon the program, causing a computer to perform the method further comprising:
learning an analysis model including a fourth neural network and a fifth neural network each of which is composed of an input layer and an output layer and to which the subsets of the set are inputted respectively, and a sixth neural network to which an inner product of outputs from the fourth neural network and the fifth neural network is inputted and which outputs a predicted data value for the prediction target type as of the prediction target time; and
calculating and outputting weights of respective elements included in the set, based on the fourth neural network and fifth neural network.

11. An information processing device comprising:
a data acquisition means for acquiring time-series data values for at least one of a prediction target type and another type that potentially affects the prediction target type; and
a prediction model learning means for learning a prediction model including a first neural network and a second neural network to which subsets obtained by dividing a set that includes the time-series data values as elements are inputted respectively, and a third neural network to which an inner product of outputs from the first neural network and the second neural network is inputted and which outputs a predicted data value for the prediction target type as of a prediction target time.
